(19) United States
(12) Patent Application Publication
(10) Pub. No.: US 2006/0261316 A1
(43) Pub. Date: Nov. 23, 2006

(54) Conductive ink, preparation method thereof and conductive board

(75) Inventors: Byung-Ho Jun, Seoul (KR); Sung-Il Oh, Seoul (KR); Kwi-Jong Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD, Suwon-si (KR)

(21) Appl. No.: 11/437,812

(22) Filed: May 22, 2006

(30) Foreign Application Priority Data
May 23, 2005 (KR) 10-2005-0043254

(51) Int. Cl. H01B 1/12

(52) U.S. Cl. 252/500

(57) ABSTRACT

The present invention relates to a conductive ink having low curing temperature, high stability of dispersion and high conductivity, and the preparation method thereof. The present invention provides a conductive ink comprising a) a metal mixture of metal precursor and amine-based compound; b) metal nano particles capped by a dispersant; and c) an organic solvent. Also, the present invention provides a conductive board having low curing temperature and high conductivity, fabricated using the conductive ink.

### CROSS-REFERENCE TO RELATED APPLICATIONS

This application claims the benefit of Korean Patent Application No. 2005-0043254 filed on May 23, 2005 with the Korea Industrial Property Office, the contents of which are incorporated here by reference in their entirety.

### BACKGROUND

1. Technical Field

The present invention relates to a conductive ink, a preparation method thereof and a conductive board.

2. Description of the Related Art

There is a demand for the formation of micro-circuit lines, in which the width of the conductive circuit lines in electronic components or the pitch between wires is narrow.

Since conventional etching and screen printing methods show a limit in forming micro-circuit lines, formation of micro-circuit lines by an ink-jet method has been recently proposed. In this method, a metal nano ink containing metal nano particles or an organic metal mixture containing a precursor is used. Also, a thin and flexible polymer board has been proposed for small and light electronic products. However, in spite of the merits described above, a polyimide board, an example of a polymer board, shows Tg of 200 to 250° C. and cannot thus endure against high curing temperature, therefore has a limit in use.

In case of forming micro-circuit lines using the metal nano ink, the curing temperature for giving the conductivity is usually high, so that it causes changes of physical properties or bends of the polymer board and results in limitations in producing polymer boards having excellent properties.

In addition, the stability of the metal nano ink decreases as the content of the metal nano particles of the ink dispersed in an aqueous system is raised for enhancing the conductivity. Further, there is a problem when the metal nano particles are melted by curing, gaps between particles are generated, and the conductivity of the circuit lines falls down because the resulting gaps interfere with current flow.

In case micro-circuit lines are formed using an organic metal mixture, the problem as in the above can be solved since the metal nano particles are not included in the ink. However, there are still problems that it is difficult to form even heights of the ejected ink for conductive circuit lines from the organic metal mixture, and to form circuit lines having enough conductivity required by a single ink-ejection.

### SUMMARY

It is therefore an object of the present invention to provide a conductive ink comprising a) a metal mixture of a metal precursor and an amine-based compound; b) metal nano particles capped by dispersant; and c) an organic solvent.

It is another object of the present invention to provide a preparation method of the conductive ink comprising:

a) forming a metal mixture of a metal precursor and an amine-based compound; and

b) mixing the metal mixture and metal nano particles capped by dispersant in an organic solvent.

It is further another object of the present invention to provide a conductive board fabricated by forming circuit lines on a base substrate with the conductive ink by an ink-jet method, and curing the base substrate at 60 to 150° C.

### DETAILED DESCRIPTION

One aspect of the present invention provides a conductive ink comprising a) a metal mixture of a metal precursor and an amine-based compound; b) metal nano particles capped by dispersant; and c) an organic solvent.

Another aspect of the present invention provides a preparation method of a conductive ink comprising:

a) forming a metal mixture of a metal precursor and an amine-based compound; and

b) mixing the metal mixture and metal nano particles capped by dispersant in an organic solvent.

Herein, a metal component of the metal precursor and metal nano particles may include at least one selected from the group consisting of silver, copper, nickel, gold, platinum, palladium and iron.

The metal precursor may include at least one selected from the group consisting of nitrates, carbonates, chlorides, phosphates, borates, oxides, sulfonates, sulfates, stearates, myristates, and acetates. According to a preferable example, the metal precursor may include at least one selected from the group consisting of AgNO₃, AgBF₄, AgPF₆, Ag₂O, CH₃COOAg, AgCF₃SO₃, Cu(NO₃), CuCl₂, CuSO₄, NiCl₂, Ni(NO₃)₂, and NiSO₄.

The amine-based compound may have a formula of CH₃(CH₂)ₙNH₂, wherein n is an integer from 1 to 19, and may include at least one selected from the group consisting of butylamine, pentylamine, hexylamine, heptylamine, octylamine, nonylamine, decylamine and undecylamine.

A molar ratio of the metal precursor and the amine-based compound in the mixture may range from 1:2 to 1:10, a size of the metal nano particle may range from 1 to 10 nm, and the organic solvent may be a hydrophobic solvent. Also, 1 to 1000 parts by weight of the metal nano particle may be mixed based to 1 part by weight of the metal mixture.

Another aspect of the present invention provides a conductive board fabricated by the process of forming circuit lines on a base substrate with the conductive ink by an inkjet method, and curing the base substrate at 60 to 150° C.

Hereinafter, the present invention will be described in detail with reference to the accompanying preferred examples.

1) Metal Mixture

(1) Metal Precursor

A metal included in a metal precursor and a metal in metal nano particles may be identical or different, but it is preferable to be identical. This metal component provides conductivity in circuit lines. The metal component in the metal precursor may include one or more metals selected from the group consisting of silver (Ag), copper (Cu), nickel (Ni), gold (Au), platinum (Pt), palladium (Pd), and iron (Fe).

Specific examples of the metal precursor containing a metal component may include inorganic acid salts such as nitrates, carbonates, chlorides, phosphates, borates, oxides, sulfonates, and sulfates, etc., and organic acid salts such as stearates, myristates, and acetates, etc. of these metals. More specific examples of the metal precursor may include a silver precursor such as AgNO₃, AgBF₄, AgPF₆, Ag₂O, CH₃COOAg, AgCF₃SO₃, and AgClO₄, a copper precursor such as Cu(NO₃), CuCl₂, and CuSO₄, and a nickel precursor such as NiCl₂, Ni(NO₃)₂, and NiSO₄, etc.

(2) Amine-Based Compound

The metal precursors described above are generally known to be dissociated well in a hydrophilic solvent. As a hydrophobic solvent is used to improve stability of dispersion in the present invention, an amine-based compound is used to dissociate a metal precursor and mix well with an organic solvent. That is, the amine-based compound functions as a hydrophobic solvent to form a metal mixture.

The amine-based compound according to a preferable example may have a formula of CH₃(CH₂)ₙNH₂, where x is an integer from 1 to 19. Since the amine-based compound is used to dissociate the metal precursor, it may be desirable to be liquid. In the present invention, a primary amine as described above is used to reduce a curing temperature of the conductive ink prepared. Examples of such an amine-based compound, wherein n is an integer from 2 to 9, may include at least one selected from the group consisting of propylamine, butylamine, pentylamine, hexylamine, heptylamine, octylamine, nonylamine, decylamine and undecylamine, preferably butylamine and propylamine, because butylamine and propylamine have lower boiling points and superior characteristics in dissociating silver salts than any other primary amine. Even if decylamine of the amine-based compounds is solid, it may be used by heating or dissolving it in other solvents in the process.

2) Metal Nano Particles

(1) Dispersant

To maintain stability of dispersion without aggregation between particles, metal nano particles are capped by a dispersant. For capping molecules, one or more compounds having lone pair electrons of oxygen, nitrogen, and sulfur atom which allows coordinate covalent bonds with metal nano particles may be used. Functional groups having N atom may include amino groups, and compounds having the amino group may include alkylamines. The Functional groups having S atom may include sulfanyl groups and sulfide-typed sulfan groups, and compounds having these functional groups may include alkanethiols. Functional groups having O atom may include carboxyl groups, hydroxyl groups and ether-typed oxy group, and compounds having hydroxyl group may include alkanediols.

According to the present invention, the dispersant is not limited to the compounds described above, and any compound may be used which can disperse metal nano particles stably and can be bonded coordinately to the metal nano particles.

It is preferable to use an alkylamine as a dispersant in case that the amine-based compound is used as a solvent to form a metal mixture. The reason is that the amine-base compound could mix well with the metal nano particles when metal nano particles are capped by N atoms. Specific examples of alkyl amine may include dodecylamine, oleylamine and hexadecylamine. Since the capping molecules are supposed to be removed by curing to provide an improved electrical conductivity of circuit lines, it is preferable that a dispersant can be easily removed at a low temperature.

(2) Metal Nano Particles

A metal component of metal nano particles may include one or more selected from the group consisting of silver (Ag), copper (Cu), nickel (Ni), gold (Au), platinum (Pt), palladium (Pd), and iron (Fe) and an alloy thereof.

According to the present invention, a size of the metal nano particles may range from 1 to 20 nm, preferably from 1 to 10 nm. When the size of the metal particle is 10 nm or less within nano size range, a melting point of the metal is getting to approximately 250° C. or lower.

Therefore, it is preferable to use metal nano particles of 10 nm or smaller to prepare a conductive ink which can be suitable for polymer boards having a low curing temperature.

In case of forming circuit line only from metal nano particles of small size such as described above, without including a metal mixture, low-temperature curing is possible because of low melting point of metal nano particles. However, conductivity may be decreased due to unexpectedly generated air gaps. Therefore, according to a preferred example of the present invention, the metal mixture fills the air gaps between metal nano particles, so that it allows forming circuit line having high conductivity even at low-temperature curing.

3) Organic Solvent

A conductive ink is formed by mixing a metal mixture with metal nano particles and dissolving them in an organic solvent. For an organic solvent, use of a nonpolar solvent is preferable since it shows higher dispersion stability of metal nano particles than use of conventional aqueous solvents. A representative nonpolar solvent is a hydrocarbon-based compound. Preferred examples of the hydrocarbon-based compound include hexane, octane, decane, tetradecane, tetradecene, hexadecane, 1-hexadecyne, octadecene, 1-octadecyne, toluene, xylene and chlorobenzoic acid, etc.

4) Additive

The conductive ink of the present invention may selectively comprise additives in consideration of adhesive property, viscosity, trail shape of ink ejection, head wetness, and the like. These additives may be used for providing desired purpose.

5) Preparation of a Conductive Ink

According to a preferred embodiment, a molar ratio of the metal precursor and the amine-based compound in the mixture may be from 1:2 to 1:10, preferably 1:2. The metal precursor is not dissociated if a molar ratio thereof is lower than 1:2. On the other hand printing by an ink-jet method is difficult due to high viscosity of the metal mixture if a molar ratio is higher than 1:10.

The gaps between metal nano particles are filled with the metal mixture, followed by curing, capping molecules and organic components are removed, and then metal component only remains. Therefore, it is possible to form circuit line of higher conductivity by filling the gaps with the fine metal nano particles provided by the metal precursor than that composed of metal nano particles only.

It is preferable to mix 1 to 1000 parts by weight of the metal nano particles based to 1 part by weight of the metal mixture prepared above. For desirable conductivity, it may be preferable to use metal nano particles having nano size of metal additionally rather than to add more of the metal precursor in an ion state dissociated in the metal mixture. When less than 1 part by weight of metal nano particles is used, relative to 1 part by weight of the metal mixture, gaps between metal nano particles are too large to be filled with the fine metal particles provided by metal precursors. As a result, it deteriorates conductivity and may be difficult to form circuit line having even height due to lowered viscosity.

In the meantime, when more than 1000 parts by weight of metal nano particles are mixed relative to 1 part by weight of the metal mixture, it is difficult to eject the conductive ink by the ink-jet method due to high viscosity. So, it is desirable to mix 100 parts by weight of metal nano particles with 1 part by weight of the metal mixture in respect of viscosity and conductivity of the ink.

6) Conductive Board

A surface of a base substrate like a polymer board is washed, a pre-designed circuit line pattern is transferred thereto by a photolithography or screen printing method, and a conductive ink is printed on the base substrate in correspondence with the circuit line pattern transferred by an ink-jet method.

The conductive ink and preparation method thereof are the same as described in detail above. Organic components such as amine-based compound, capping layer, and organic solvent are removed if the base substrate is cured at a reducing atmosphere. The metal nano particles unite one another, the gaps between particles are filled with fine metal particles provided by the metal precursor and then circuit line of the excellent conductivity is formed. At this time, the curing temperature may be 60 to 150° C.

Such a prepared board may be then optionally laminated to provide a multilayer board. A film is plated on the formed conductive circuit line and a solder resist printing stage is followed, so that undesirable contacts in the soldering of the part mounting process can be avoided. Thereafter, the symbol mark printing and surface finishing are performed and followed by terminal plating or processing of hole and appearance, to obtain the completed conductive board.

Hereinafter, the conductive ink, preparing method thereof, and conductive board will be described in further detail with reference to accompanying examples.

### EXAMPLE 1

(1) Silver nitrate and dodecylamine were mixed with a molar ratio 1:2 and heated at 100° C. to form fine silver nano particles. After removing an excess amount of organic material and solvent by washing and centrifugation, metal nano particles of 5 nm capped by the amine were recovered.

(2) Silver nitrate and butyl amine were mixed with a molar ratio 1:2 and sonicated or stirred at 50° C. to obtain a metal compound.

(3) 100 g of the recovered metal nano particles and 1 g of the metal compound were dissolved in tetradecane, and additives were mixed optionally thereto, to obtain a conductive ink. The prepared conductive ink was ejected on a polyimide film by an ink-jet printer. After curing the film at 150° C. for 30 minutes, and its conductivity measured was 3.1×10⁷ (Ω·m)⁻¹.

### Comparative Example

100 g of nano silver particles of 5 nm were added into an aqueous solution of ethanol and ethylene glycol, and dispersed using an ultra-sonicator to prepare a conductive ink. After printing on a polyimide film with the conductive ink, and the film was cured at 350° C. for 5 minutes, and its conductivity measured was 2.1×10⁷ (Ω·m)⁻¹.

As described above, the present invention provides a conductive ink having low curing temperature, high stability of dispersion and high conductivity, and the preparation method thereof. Also, the present invention provides the conductive board having low curing temperature and high conductivity, fabricated using the conductive ink.

Although a few embodiments of the present invention have been shown and described, it will be appreciated by those skilled in the art that changes may be made in these embodiments without departing from the principles and spirit of the present invention, the scope of which is defined in the appended claims and their equivalents.

What is claimed is:

1. A conductive ink comprising a) a metal mixture of a metal precursor and an amine compound; b) metal nano particles capped by a dispersant; and c) an organic solvent.

2. The conductive ink of claim 1, wherein a metal component of the metal precursor and the metal nano particles includes one or more selected from the group consisting of silver (Ag), copper (Cu), nickel (Ni), gold (Au), platinum (Pt), palladium (Pd), and iron (Fe).

3. The conductive ink of claim 2, wherein the metal precursor includes one or more selected from the group consisting of nitrates, carbonates, chlorides, phosphates, borates, oxides, sulfonates, sulfates, stearates, myristates, and acetates.

4. The conductive ink of claim 3, wherein the metal precursor includes one or more selected from the group consisting of AgNO₃, AgBF₄, AgPF₆, Ag₂O, CH₃COOAg, AgCF₃SO₃, AgClO₄, Cu(NO₃), CuCl₂, CuSO₄, NiCl₂, Ni(NO₃)₂, and NiSO₄.

5. The conductive ink of claim 1, wherein the amine-based compound has a formula of CH₃(CH₂)ₙNH₂, wherein n is an integer from 1 to 19.

6. The conductive ink of claim 5, wherein the amine-based compound is one or more selected from the group consisting of butylamine, pentylamine, hexylamine, heptylamine, octylamine, nonylamine, decylamine, and undecylamine.

7. The conductive ink of claim 1, wherein a molar ratio of the amine-based compound to the metal compound ranges from 2 to 10.

8. The conductive ink of claim 1, wherein a size of the metal nano particle ranges from 1 to 10 nm.

9. The conductive ink of claim 1, wherein the organic solvent is a nonpolar organic solvent.

10. The conductive ink of claim 1, wherein 1 to 1000 parts by weight of the metal nano particles are mixed, based to 1 part by weight of the metal mixture.

11. A preparation method of a conductive ink comprising:
a) forming a metal mixture of a metal precursor and an amine-based compound;
b) mixing the metal mixture and metal nano particles capped by a dispersant in an organic solvent.

12. The method of claim 11, wherein a metal component of the metal precursor and the metal nano particles includes one or more selected from the group consisting of silver (Ag), copper (Cu), nickel (Ni), gold (Au), platinum (Pt), palladium (Pd), and iron (Fe).

13. The method of claim 12, wherein the metal precursor includes one or more selected from the group consisting of nitrates, carbonates, chlorides, phosphates, borates, oxides, sulfonates, sulfates, stearates, myristates, and acetates.

14. The method of claim 13, wherein the metal precursor includes one or more selected from the group consisting of AgNO₃, AgBF₄, AgPF₆, Ag₂O, CH₃COOAg, AgCF₃SO₃, AgClO₄, Cu(NO₃), CuCl₂, CuSO₄, NiCl₂, Ni(NO₃)₂, and NiSO₄.

15. The method of claim 11, wherein the amine-based compound has a formula of CH₃(CH₂)ₙNH₂, wherein n is an integer from 1 to 19.

16. The method of claim 15, wherein the amine-based compound is one or more selected from the group consisting of butylamine, pentylamine, hexylamine, heptylamine, octylamine, nonylamine, decylamine, and undecylamine.

17. The method of claim 11, wherein a molar ratio of the amine-based compound to the metal compound ranges from 2 to 10.

18. The method of claim 11, wherein a size of the metal nano particle ranges from 1 to 10 nm .

19. The method of claim 11, wherein the organic solvent is a nonpolar organic solvent.

20. The method of claim 11, wherein 1 to 1000 parts by weight of the metal nano particles are mixed, based to 1 part by weight of the metal mixture.

21. A conductive board fabricated by forming circuit lines in a base substrate using the conductive ink of claim 1 by an ink-jet method, and curing the base substrate at 60 to 150° C.
